(19) United States
(12) Patent Application Publication
(10) Pub. No.: US 2017/0212277 A1
(43) Pub. Date: Jul. 27, 2017

(54) A NOVEL MANUFACTURING PROCESS FOR TORIC CONTACT LENSES AND OTHER SPECIALTY LENSES UTILIZING A 3-DIMENTIONAL PRINTER

(71) Applicant: HPM Company, Barrington Hills, IL (US)

(72) Inventor: L. Lawrence Chapoy, Barrington Hills, IL (US)

(21) Appl. No.: 15/327,702

(22) PCT Filed: Jul. 21, 2015
(86) PCT No.: PCT/US15/41376

§ 371 Date: Jan. 20, 2017

Related U.S. Application Data
(60) Provisional application No. 62/027,115, filed on Jul. 21, 2014.

(51) Int. Cl. G02B 1/04; G02C 7/02; B33Y 50/02; B29D 11/00; B29C 67/00; B33Y 70/00; G02C 7/04; B33Y 10/00

(52) U.S. Cl. CPC G02B 1/041; G02C 7/049; G02B 1/043; G02C 7/024; B33Y 10/00; B29D 11/00038; B29C 67/0055; B33Y 70/00; B33Y 50/02; B29C 67/0088; G02C 2202/16; B29K 2033/12

(57) ABSTRACT

The present invention uses 3 dimensional printer technologies to create specialized contact lenses by building up optical features onto a shell of a contact lens. In this context, a shell is a curved disk with the same radius of curvature on the front and back surface providing a spherical base curve to fit the cornea and no optical power on the front curve. Starting with such a shell, the present invention provides that the 3-dimensional printer is utilized to build optical features on to the front surface.

### RELATED APPLICATIONS

This application claims priority from U.S. Provisional Patent Application Ser. No. 62/027,115, filed Jul. 21, 2014 of the same title and PCT Application No. PCT US2015/41376 filed on Jul. 21, 2015 of the same title.

### TECHNICAL FIELD

The present invention relates to a method for manufacturing ophthalmic devices for insertion in the eye using a 3 dimensional printer, including but not limited to specialized contact lenses, such as toric lenses, and other types of specialty lenses such as in-lays, on-lays, intra-ocular lenses (IOL's), and instrument lenses.

### BACKGROUND OF THE INVENTION

The manufacturing of contact lenses has evolved over the years to reflect increased volume of lenses and changing available technologies. Initially, lenses were lathed from so-called buttons, i.e disks cut from polymerized rods. The introduction of automated lathing technologies allowed for increased volumes and cost reductions. With the advent of two week disposable lenses, volumes grew rapidly from the prior state where a lens was carefully cleaned and disinfected for a 1-2 year use life cycle. Direct casting of lenses from individual single use injection molded contact lens molds became a reality at these larger volumes.

While the cast molding process is a low cost manufacturing process for large volume SKU's, it becomes inefficient for low volume items: out-of-bell-curve spherical lenses, toric lenses, multi-focal lenses, specialty keratoconus lenses, etc. Manufacturing of viable lot sizes results in excessive working capital because of large inventories as well as issues with expiration dating. Clearly, another process is required for the rational manufacturing of these types of specialty lenses. For small lot sizes change over costs become onerous.

The same manufacturing strategy and logic applies for any low volume production of other ophthalmic lenses such as IOL's, in-lays, on-lays etc. or specialty purpose lenses of any kind, ophthalmic or otherwise.

Recently, there have been advances in the accessibility of 3-dimensional printers for use in traditional manufacturing. They are capable of building up a 3-dimensional structure by printing and curing a multitude of thin layers of ink in a pre-determined pattern onto a substrate. The print is applied like a continuous dot matrix pattern in 2-dimensions to selectively form and buildup the microstructure in the 3^{rd} dimension. Ink is cured as required by for example UV illumination to lock-in the structure of the successive layers. The result is equivalent to a printed analog of MEMS Technology. It is expected that its future use will be wide-spread as the technology matures. At present, however, it is largely a solution looking for a problem.

Successive layers can be built up for example by using jets to deposit a pre-determined pattern of ink by a CAD/CAM technique where the pattern is stored in the computer and drives the jets to make deposits in a predisposed way. Alternatively, a uniform layer can be deposited which is subsequently cured selectively in 2-dimensions to form the pattern. Non-crosslinked material can then be washed away before the next layer is applied. This selective crosslinking is a micro-lithographic process that can be used either in connection with a uniform beam of crosslinking light and a mask or a beam of light which is spatially modulated in intensity. Alternatively, a focused light beam, laser or otherwise, can walk across the 2-D surface in a predeteremined pattern or fashion as dictated or programmed by a computer which shootspulses of crosslinking light as directed or instructed by the computer.

### SUMMARY OF THE INVENTION

The present invention is directed towards a method for manufacturing ophthalmic devices for insertion in the eye using a 3 dimensional printer, including but not limited to specialized contact lenses, such as toric lenses, and other types of specialty lenses such as in-lays, on-lays, IOL's, and instrument lenses. Whereas the method of the present invention is explained in detail as to the manufacture of specialty contact lenses, it is understood the present invention may be utilized to manufacture any ophthalmic lens types including contact lenses other than torics, IOL's, in-lays, on-lays, and specialty lenses of any kind, ophthalmic or otherwise. As discussed above, a 3-dimensional printer can create successive layers that build up upon a blank shell to create optical features on the blank shell. The printer's jets deposit a pre-determined pattern of ink programmed by a CAD/CAM technique where the pattern is preprogrammed and stored in the computer and drives the jets to make deposits in a predisposed way. Alternatively, a uniform layer can be deposited which is subsequently cured selectively in 2-dimensions to form the preprogrammed pattern. Non-crosslinked material can then be washed away before the next layer is applied. This selective crosslinking is a micro-lithographic process that can be used either in connection with a uniform beam of crosslinking light and a mask or a beam of light which is spatially modulated in intensity. Alternatively, a focused light beam, laser or otherwise, can walk across the 2-D surface in a predeteremined pattern or fashion as dictated or programmed by a computer which shoots pulses of crosslinking light as directed or instructed by the computer.

### DETAILED DESCRIPTION OF INVENTION

The present invention uses 3 dimensional printer technologies to create ophthalmic devices including specialized contact lenses by building up optical features onto a shell of a contact lens. In this context, a shell is a curved disk with the same radius of curvature on the front and back surface providing a spherical base curve to fit the cornea and no optical power on the front curve. Starting with such a shell, the present invention provides that the 3-dimensional printer is utilized to build optical features on to the front surface: + or − spherical power, cylinder power to make toric lenses, complicated patterns to make simultaneous vision multi-focals, aspheric designs, cosmetic features to show left/right or lens inversion, sensors to provide diagnostics for tear markers or measures of deposits to indicate the desirability/necessity to change lenses, patterns for cosmetic and prosthetic lenses, a smooth surface top coat over cosmetic features, a hydrophilic lubricious surface layer, etc.. Multiple materials can be applied with a turret of jets dispensing different inks to avoid, cleaning and purging of the materials. While the examples given above specifically refer to contact lenses, the present invention may be applied to the manufacture of other lens types of low volume specialty lenses, i.e. in-lays, on-lays, IOL's, instrument lenses etc.

### BEST MODE FOR CARRYING OUT THE INVENTION

In one embodiment that has been found to achieve the best results, the method is comprised of the following steps:

a) At least one blank is produced using double sided molding. Such blank may be a contact lens, IOL, in-lays, on-lays or other lens types. Such lens types are collectively referred to as “ophthalmic lenses”. This classification has been expanded in recent years as the technology has evolved and new types of lenses have been derived for refractive correction. In the present invention, there is at least one SKU's to be molded of such blanks. This at least one SKU may be related to gross features such as different base curves, materials or diameters.

b) The at least one blank is loaded into a magazine for presentation to a 3-D printer.

c) A SKU may be printed on the at least one blank using a suitably programmed computer for interfacing with the 3 dimensional printer. In the present invention, any number of printable SKU's can be pre-loaded into a computer for interfacing with the 3-D printer. In one embodiment, a full line of cosmetic toric contact lenses for use with astigmatics will comprise the order of 100,000 SKU's that can all be generated from a single blank

d) The blanks can be transformed into the final part on a demand basis. This step involves building up a lens onto the blank by depositing successive layers using 3-dimensional printing. The blank then in effect becomes a physical carrier for the active lens.

The present invention combines the efficiency of mass molding and 3 dimensional printer technology by providing for mass blanks(i.e., the major portion of the final lens mass) to be produced using the molding process and for optical features, essentially a tweaking of the blank by adding optical power to the surface of the blank, to be added using the 3 dimensional printer. The inherent efficiency of the molding process therefore is fully exploited. Alternatively, optics such as the cylindrical component of the toric lens can be added to the back surface which may actually improve the base curve corneal fit.

Step d above involves building up a lens onto the blank by depositing successive layers using 3-Dimensional Printing. In one embodiment, a simple spherical contact lens for correcting myopia is created as a concave bowl structure onto the blank created by the molding process. There is constant lens power across any radius independent of angle. In another embodiment, a toric lens for correcting astigmatism can be constructed by building up the blank in a similar manner such that there is constant lens power along any radius, but that power map has the added feature/ complication of being angularly dependent. In yet another embodiment, an aspheric lens for use with presbyopia is constructed similarly but with optical power varying continuously along any radius from the center point to the periphery. Additional variations and constructs can be created by depositing a colored cosmetic layer with or without a topcoat to smooth out the bumps resulting from the cosmetic pattern. Each color can be dosed from a separate jet mounted in a turret.

In one embodiment, the final layer of the lens could be a totally different material to make the outer surface of the lens lubricious and comfortable to the wearer. Such different material could be dispensed from a separate jet in the turret of the 3-d printer. The use of separate jets from a turret obviates the need for cleaning and purging the jets during the manufacturing process.

One benefit of the present invention over the prior art is that such process precludes unwanted inventory for infrequently called upon SKU's. Each final part can be made on a truly Made to Order basis, MTO: Order entry, manufacturing execution, final packaging and directly to shipping. Individual traceability would allow for product to be co-mingled for subsequent steps such as extraction, packaging and sterilization. Efficiencies of scale would not be sacrificed. A software validation, however, would be required to realize this new manufacturing paradigm to ensure correct labeling of the specialized contact lenses is achieved. This could be achieved for example by use of an RF tag on the lens transporter carrier tray.

The present invention does not require costly and time consuming, cleaning, purging, changeovers, adjustments, line clearances, inventories of many mold SKU's etc. The low cost and high volume efficiencies of double sided molding can be fully preserved for lot sizes as small as one by still molding the basic lens blank Molding costs are reduced since only a single or handful of molds are required. This for example drastically reduces the number of costly injection molding inserts of optical quality that are required. That costly mechanical feature is replaced by the computer steering of the 3-Dimensional Printer.

Further, the present invention addresses the issues relating to working capital and storage of inventories as well as expiration dating for seldom called upon SKU's, which will be greatly reduced. Production costs for low volume SKU's should be greatly reduced.

The ink formulations for the present invention may be formulated as follows: A low viscosity easy flow state of ink is desired during the application, but a rapid buildup of yield stress is desirable to stabilize the “printed image” in time on the substrate until it can be cured/polymerized/cross-linked. A surface energy match is desirable between the substrate and the printed image to preserve the resolution of the print on the substrate either by avoiding beading-up or spreading-out of the printed image. The liquid phase, solvent of the ink should be a cross-linkable/polymerizable monomer. This can be thickened to give higher viscosity/thixotropy ink by dissolving polymer in the monomer. The monomer system chosen should be compatible as noted above with the substrate polymer. The liquid phase will all be converted into polymer. There is no unreacted solvent. Yield stress promoters can be added as desirable. Using this manufacturing strategy, there will be no extractables. Alternatively, a non-reactable solvent can be added to the ink to compensate for the eventual swelling that the lens will experience when being hydrated. This will minimize aberrations, birefringence and shear stresses resulting from the hydration. Shear stresses can result in delamination. Each ink should be formulated accordingly to minimize volume change and swelling during the solvent exchange with water. For contact lenses, avoiding toxic extractables is an important consideration. Given this, an effective UV initiator should be part of the ink formulation as each successive layer is photo-cured. To further minimize extractables, polymerization could be driven further by a short thermal cycle. This would require a thermal initiator as well. Dual purpose phto-/thermal-initiators are well known, e.g. Vazo 52 or Vazo 64. If the ink solvent, including reactable monomers, swells the substrate, it will form an IPN, Inter-penetrating Network, which will improve the adhesion of the successive layers and thereby the strength of the aggregate. Care should be exerted to ensure that the optimized ink has the ability to adequately swell the surface of the substrate thereby giving it the ability to form the IPN in order to generate good adhesion between the successive layers. The cured successive layers should have approximately the same swelling factor in water as the substrate polymer to avoid the formation of destructive shear stresses during the swelling process for soft lenses. Following these general principles, one can formulate specific inks for substrates comprised of different materials: Hydroxyethylmethacrylate (HEMA) based hydrogels of varying water content, non-HEMA based hydrogels of varying water content, silicones, low/zero water acrylics, silicone hydrogels, etc.

In one embodiment, the present invention uses 3 dimensional printer technologies to create specialized contact lenses without the use of a shell but rather utilizes the 3-dimensional printer to initialize the base structure of the contact lenses and then build up optical features onto such base structure. As with the embodiments discussed above, the present invention utilizes a 3 dimensional printer to build optical features on to the surface of a constructed lenses such as spherical power, cylinder power to make toric lenses, complicated patterns to make simultaneous vision multi-focals, aspheric designs, cosmetic features to show left/right or lens inversion, sensors to provide diagnostics for tear markers or measures of deposits to indicate the desirability/necessity to change lenses, patterns for cosmetic and prosthetic lenses, a smooth surface top coat over cosmetic features, a hydrophilic lubricious surface layer, etc..

In another embodiment, the present invention may be used to construct any devices for insertion or implantation in the eye utilizing a 3 dimensional printer including but not limited to in-lays, on-lays, corneal rings, etc. The present invention may be further utilize a 3 dimensional printer to produce spectacle lenses and lenses for instrumentation.

The foregoing detailed description is given for clearness of understanding only, and no unnecessary limitations should be understood therefrom, as modifications will be obvious to those skilled in the art.

1. A method of making at least one ophthalmic device, the method comprising printing on a substrate using a 3 dimensional printing process.

2. A method of making at least one ophthalmic device according to claim 1 wherein said substrate is at least one blank shell.

3. A method for making at least one ophthalmic device according to claim 2, wherein the method includes the step of producing the at least one blank shell using double sided molding.

4. A method for making at least one ophthalmic lens according to claim 2, wherein at least one black shell is loaded into a magazine for presentation to a 3-D printer.

5. A method for making at least one ophthalmic lens according to claim 2, wherein a 3-dimensional printer constructs optical features on the at least one blank by depositing successive layers using the 3-dimensional printer.

6. A method of making at least one ophthalmic device according to claim 1, wherein the at least one ophthalmic lens is at least one specialized contact lens.

7. A method of making at least one ophthalmic device according to claim 1, wherein the at least one ophthalmic lens is an ophthalmological in-lay.

8. A method of making at least one ophthalmic device according to claim 1, wherein the at least one ophthalmic lens is an ophthalmological on-lay.

9. A method of making at least one ophthalmic device according to claim 1, wherein the at least one ophthalmic lens is a corneal ring.

10. A method of making at least one ophthalmic device according to claim 1, wherein the at least one ophthalmic lens is an IOL.

11. A method for making at least one ophthalmic device according to claim 1, wherein the ink utilized by the 3 dimensional printer is comprised of HEMA based hydrogels of varying water content.

12. A method for making at least one ophthalmic device according to claim 1, wherein the ink utilized by the 3 dimensional printer is comprised of non-HEMA based hydrogels of varying water content.

13. A method for making at least one ophthalmic device according to claim 1, wherein the ink utilized by the 3 dimensional printer is comprised of silicone.

14. A method for making at least one ophthalmic device according to claim 1, wherein the ink utilized by the 3 dimensional printer is comprised of low/zero water acrylics.

15. A method for making at least one ophthalmic device according to claim 1, wherein the ink utilized by the 3 dimensional printer is comprised of silicone hydrogels.

16. A method for making at least one medical device for insertion into a patient's eyes, the method comprising printing on a contact lens using a 3 dimensional printing process.

17. A method for making at least one medical device according to claim 15, wherein a 3-dimensional printer constructs the predetermined features of the device by depositing successive layers using the 3-dimensional printer.

18. A method for making at least one medical device according to claim 15, wherein the medical device to be constructed is an ophthalmological in-lay.

19. A method for making at least one medical device according to claim 15, wherein the medical device to be constructed is an ophthalmological on-lay.

20. A method for making at least one medical device according to claim 15, wherein the medical device to be constructed is a corneal ring.

21. A method for making at least one medical device according to claim 15, wherein the medical device to be constructed is an IOL.

22. A method for making at least one medical device according to claim 15, wherein the ink utilized by the 3 dimensional printer is comprised of HEMA based hydrogels of varying water content.

23. A method for making at least one medical device according to claim 15, wherein the ink utilized by the 3 dimensional printer is comprised of non-HEMA based hydrogels of varying water content.

24. A method for making at least one medical device according to claim 15, wherein the ink utilized by the 3 dimensional printer is comprised of silicone.

25. A method for making at least one medical device according to claim 15, wherein the ink utilized by the 3 dimensional printer is comprised of low/zero water acrylics.

26. A method for making at least one medical device according to claim 16, wherein the ink utilized by the 3 dimensional printer is comprised of silicone hydrogels.

27. A method of developing at least one ophthalmic lens, the method comprising: receiving in a computer data input defining the optical features to be constructed on a blank shell; transmitting the design of the optical features from the computer to a 3-dimensional printer; and printing said optical features on the blank shell to create the ophthalmic lens with the 3-dimensional (3D) printer based on the designing.

28. A method of making at least one ophthalmic ns, the method comprising
a) Producing at least one blank shell using double sided molding;
b) Loading the at least one blank into a magazine for presentation to a 3-D printer; and
c) Using a 3-dimensional printer, constructing optical features on the at least one blank by depositing successive layers using 3-dimensional printer.

29. A method of developing at least one ophthalmic lens, the method comprising: receiving in a computer data input defining the lenses with predetermined optical features to be constructed; transmitting the design of the lenses with optical features from the computer to a 3-dimensional printer; and printing said optical features to create the ophthalmic lens with the 3-dimensional (3D) printer based on the designing.
